(19) United States
(12) Patent Application Publication
(10) Pub. No.: US 2026/0154346 A1
(43) Pub. Date: Jun. 4, 2026

(54) SYSTEM AND METHOD FOR PROCESSING ACTIVATION PARAMETERS

(71) Applicant: The Toronto-Dominion Bank, Toronto (CA)

(72) Inventors: Abhimanyu MUNJAL, Mississauga (CA); Steven Karl EIMER, Ottawa (CA); Shereeka MCEWAN, Toronto (CA)

(73) Assignee: The Toronto-Dominion Bank, Toronto (CA)

(21) Appl. No.: 18/964,825

(22) Filed: Dec. 2, 2024

(51) Int. Cl. G06F 16/903; G06F 3/0481

(52) U.S. Cl. CPC G06F 16/90335; G06F 3/0481

(57) ABSTRACT

A server computer system comprises a communications module; at least one processor coupled with the communications module; and a memory coupled to the at least one processor and storing processor-executable instructions which, when executed by the at least one processor, configure the at least one processor to receive a request to create a data record linked to a unique identifier; determine activation parameters associated with the data record; query a database for previously processed activation parameters linked to the unique identifier; compare the activation parameters to the previously processed activation parameters to identify at least one pending activation parameter for the data record; and generate a dynamic graphical user interface that includes the at least one pending activation parameter and at least one interface element for processing the at least one pending activation parameter.

### TECHNICAL FIELD

The present application relates to systems and methods for processing activation parameters.

### BACKGROUND

In systems managing activation parameters, repeated processing of activation parameters leads to an unnecessary consumption of computing resources. For example, the reprocessing of activation parameters increases computational load, consumes storage and bandwidth, and impacts system scalability.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 is a schematic diagram outlining various components of an artificial intelligence engine;

FIG. 4 shows, in flowchart form, an example method for identifying at least one pending activation parameter and generating a dynamic graphical user interface for processing the at least one pending activation parameter;

FIG. 5 shows an example list of activation parameters for a data record of a particular data record type;

FIG. 6 shows exemplary data records listing previously processed activation parameters;

FIG. 7 shows an example dynamic graphical user interface;

FIG. 8 shows, in flowchart form, an example method for creating a data record; and

FIG. 9 shows exemplary updated data records listing previously processed activation parameters.

Like reference numerals are used in the drawings to denote like elements and features.

### DETAILED DESCRIPTION OF VARIOUS EMBODIMENTS

Accordingly, in one aspect there is provided a server computer system comprising a communications module; at least one processor coupled with the communications module; and a memory coupled to the at least one processor and storing processor-executable instructions which, when executed by the at least one processor, configure the at least one processor to receive a request to create a data record linked to a unique identifier; determine activation parameters associated with the data record; query a database for previously processed activation parameters linked to the unique identifier; compare the activation parameters to the previously processed activation parameters to identify at least one pending activation parameter for the data record; and generate a dynamic graphical user interface that includes the at least one pending activation parameter and at least one interface element for processing the at least one pending activation parameter.

In one or more embodiments, the instructions, when executed by the at least one processor, further configure the at least one processor to send, via the communications module and to a computing device, a signal causing the computing device to display the dynamic graphical user interface; and receive, via the communications module and from the computing device, a signal indicating processing of the at least one pending activation parameter.

In one or more embodiments, the instructions, when executed by the at least one processor, further configure the at least one processor to responsive to receiving the signal indicating processing of the at least one pending activation parameter, create the data record and update another data record linked to the unique identifier to indicate the processing of the at least one pending activation parameter.

In one or more embodiments, the another data record includes a Boolean flag indicating the processing of the at least one pending activation parameter.

In one or more embodiments, when determining the activation parameters associated with the data record, the instructions, when executed by the at least one processor, further configure the at least one processor to determine a data record type of the data record; and query the database to obtain the activation parameters based on the data record type.

In one or more embodiments, the instructions, when executed by the at least one processor, further configure the at least one processor to engage an artificial intelligence engine to analyze data to identify activation parameters and generate an activation parameter data model that maps the identified activation parameters to one or more data record types; and store the activation parameter data model in the database.

In one or more embodiments, the instructions, when executed by the at least one processor, further configure the at least one processor to determine that all activation parameters associated with the data record have been processed, and responsive to determining that all activation parameters associated with the data record have been processed, create to the data record.

In one or more embodiments, the dynamic graphical user interface includes all pending activation parameters and a single interface element for processing all pending activation parameters.

In one or more embodiments, the database maintains a list of all previously processed activation parameters linked to the unique identifier.

In one or more embodiments, the previously processed activation parameters include previously processed activation parameters associated with one or more other data record types.

According to another aspect there is provided a computer-implemented method comprising receiving a request to create a data record linked to a unique identifier; determining activation parameters associated with the data record; querying a database for previously processed activation parameters linked to the unique identifier; comparing the activation parameters to the previously processed activation parameters to identify at least one pending activation parameter for the data record; and generating a dynamic graphical user interface that includes the at least one pending activation parameter and at least one interface element for processing the at least one pending activation parameter.

In one or more embodiments, the method further comprises sending, via a communications module and to a computing device, a signal causing the computing device to display the dynamic graphical user interface; and receiving, via the communications module and from the computing device, a signal indicating processing of the at least one pending activation parameter.

In one or more embodiments, the method further comprises responsive to receiving the signal indicating processing of the at least one pending activation parameter, creating the data record and updating another data record linked to the unique identifier to indicate the processing of the at least one pending activation parameter.

In one or more embodiments, the another data record includes a Boolean flag indicating the processing of the at least one pending activation parameter.

In one or more embodiments, when determining the activation parameters associated with the data record, the method comprises determining a data record type of the data record; and querying the database to obtain the activation parameters based on the data record type.

In one or more embodiments, the method further comprises engaging an artificial intelligence engine to analyze data to identify activation parameters and generate an activation parameter data model that maps the identified activation parameters to one or more data record types; and storing the activation parameter data model in the database.

In one or more embodiments, the method further comprises determining that all activation parameters associated with the data record have been processed, and responsive to determining that all activation parameters associated with the data record have been processed, creating the data record.

In one or more embodiments, the database maintains a list of all previously processed activation parameters linked to the unique identifier.

In one or more embodiments, the previously processed activation parameters include previously processed activation parameters associated with one or more other data record types.

According to another aspect there is provided a non-transitory computer readable storage medium comprising computer-executable instructions which, when executed, configure a processor to receive a request to create a data record linked to a unique identifier; determine activation parameters associated with the data record; query a database for previously processed activation parameters linked to the unique identifier; compare the activation parameters to the previously processed activation parameters to identify at least one pending activation parameter for the data record; and generate a dynamic graphical user interface that includes the at least one pending activation parameter and at least one interface element for processing the at least one pending activation parameter.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

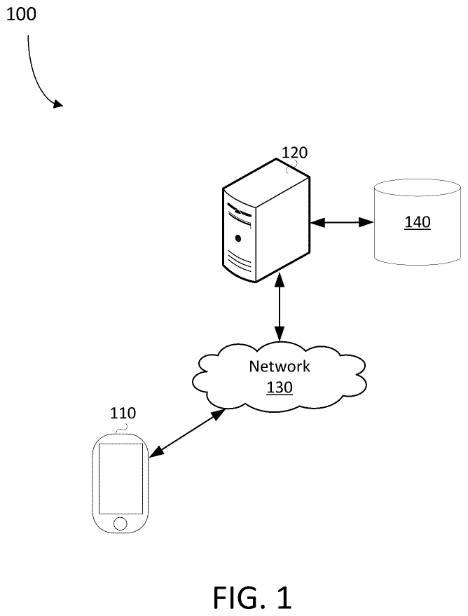

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The computing device 110 may take a variety of forms including, for example, a mobile communication device such as a smartphone, a tablet computer, a wearable computer (such as a head-mounted display or smartwatch), a laptop or desktop computer, or a computing device of another type. The computing device 110 may store software instructions that cause the computing device 110 to establish communications with the server computer system 120.

The server computer system 120 may include a database system and may maintain a database 140 that includes various data records. The data records may include data records linked to unique identifiers where each data record may correspond to one or more data record types. Example data record types may include different types of accounts such as for example resource accounts, media service accounts, etc. The resource accounts such as for example a chequing account, a savings account, a borrowing account such as for example a line of credit account, a credit card account, a loyalty point account, etc. The data records may store attributes in the form of metadata such as account type, balance, creation date, activation parameters, etc.

In one or more embodiments, activation parameters may include or represent preconditions such as for example terms and/or conditions that may be required to be processed or acknowledged to enable or access certain functionalities of the data record. The activation parameters may be stored in one or more tables within the database 140 and may be linked to one or more other data records using, for example, foreign keys and this may enable efficient querying and relationship management.

The server computer system 120 may include an artificial intelligence engine trained to analyze data to identify activation parameters and to generate an activation parameter data model that maps each activation parameter to one or more data record types that require processing of the activation parameter prior to creating or providing access to a data record of the one or more data record types.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

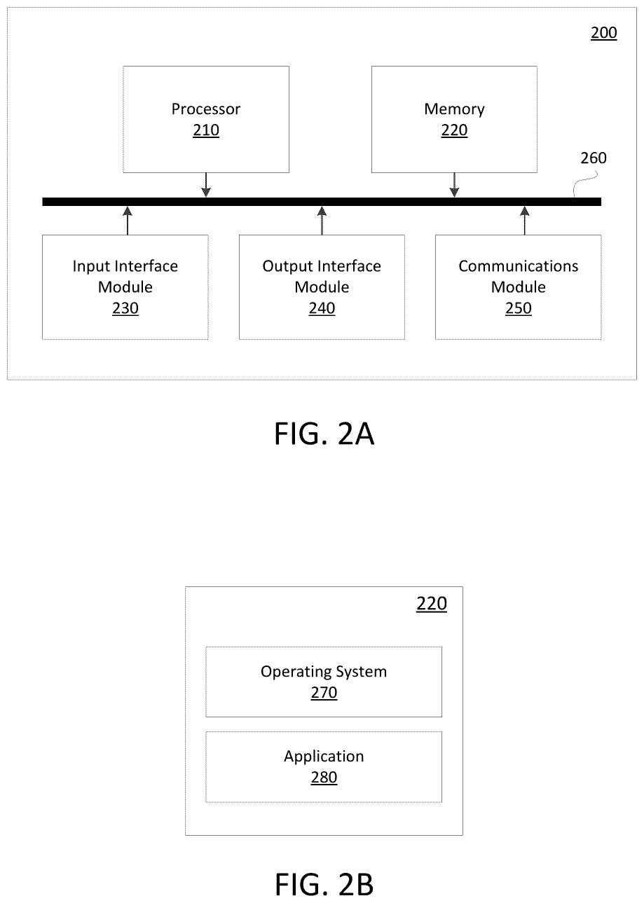

FIG. 2A is a high-level operation diagram of an example computer device 200. In some embodiments, the example computer device 200 may be exemplary of one or more of the computing device 110 and/or the server computer system 120. The example computer device 200 includes a variety of modules. For example, as illustrated, the example computer device 200, may include a processor 210, a memory 220, an input interface module 230, an output interface module 240, and a communications module 250. As illustrated, the foregoing example modules of the example computer device 200 are in communication over a bus 260.

The processor 210 is a hardware processor. Processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive, or the like. Read-only memory and persistent storage are a computer-readable medium. A computer-readable medium may be organized using a file system such as may be administered by an operating system governing overall operation of the example computer device 200.

The input interface module 230 allows the example computer device 200 to receive input signals. Input signals may, for example, correspond to input received from a user. The input interface module 230 may serve to interconnect the example computer device 200 with one or more input devices. Input signals may be received from input devices by the input interface module 230. Input devices may, for example, include a touchscreen input, keyboard, trackball, or the like. In some embodiments, all or a portion of the input interface module 230 may be integrated with an input device. For example, the input interface module 230 may be integrated with one of the aforementioned example input devices.

The output interface module 240 allows the example computer device 200 to provide output signals. Some output signals may, for example, allow provision of output to a user. The output interface module 240 may serve to interconnect the example computer device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as for example a speaker, indicator lamps (such as for example light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computer device 200 to communicate with other electronic devices and/or various communications networks. For example, the communications module 250 may allow the example computer device 200 to send or receive communications signals. Communications signals may be sent or received according to one or more protocols or according to one or more standards. For example, the communications module 250 may allow the example computer device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computer device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computer device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of memory 220.

FIG. 2B depicts a simplified organization of software components stored in memory 220 of the example computer device 200. As illustrated these software components include an operating system 270 and an application 280.

The operating system 270 is software. The operating system 270 allows the application 280 to access the processor 210, the memory 220, the input interface module 230, the output interface module 240 and the communications module 250. The operating system 270 may be, for example, Apple iOS™, Google Android™, Linux™, Microsoft Windows™, or the like.

The application 280 adapts the example computer device 200, in combination with the operating system 270, to operate as a device performing specific functions. It will be appreciated that although a single application 280 is shown, in operation the memory 220 may include more than one application 280 and different applications 280 may perform different operations.

For example, in at least some embodiments in which the computer device 200 functions as the computing device 110, the applications 280 may include a banking application. The banking application may be configured for secure communications with the server computer system 120 and may provide various banking functions such as, for example, the ability to display a quantum of value in one or more data records (e.g., display balances), configure or request that operations such as transfers of value (e.g., bill payments, email money transfers and other transfers) be performed, and other account management functions. For example, the banking application may be configured to allow a user to submit a request to create a data record.

By way of further example, in at least some embodiments in which the computer device 200 functions as the computing device 110, the applications 280 may include a web browser, which may also be referred to as an Internet browser. In at least some such embodiments, the server computer system 120 may be a web server. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g., display balances), configure or request that operations such as transfers of value (e.g. bill payments and other transfers) be performed, and other account management functions. For example, the banking interface may be configured to allow a user to submit a request to create a new data record.

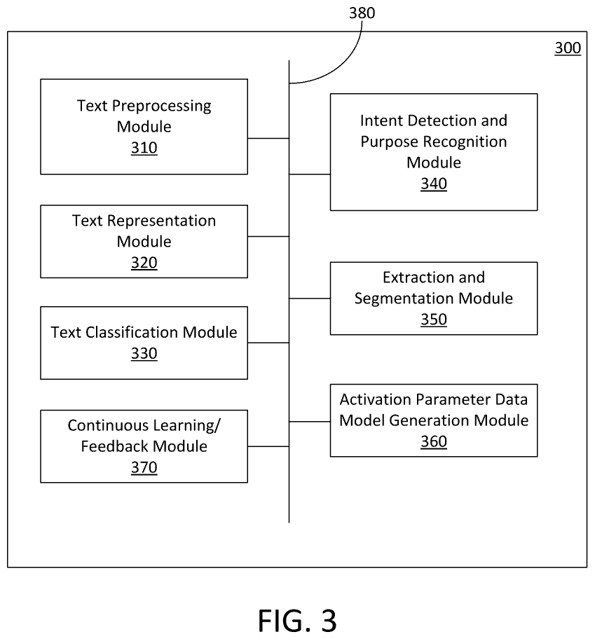

As mentioned, the server computer system 120 may include an artificial intelligence engine trained to analyze data to identify activation parameters and to generate an activation parameter data model that maps each activation parameter to one or more data record types that require processing of the activation parameter prior to creating or providing access to a data record of the one or more data record types. FIG. 3 is an example schematic diagram outlining various components of an artificial intelligence engine 300. As can be seen, the artificial intelligence engine 300 includes a text preprocessing module 310, a text representation module 320, a text classification module 330, an intent detection and purpose recognition module 340, an extraction and segmentation module 350, an activation parameter data model generation module 360, and a continuous learning/feedback module 370. The various components communicate with one another over a pipeline 380.

The text preprocessing module 310 may ingest data that includes activation parameters. In one or more embodiments, the data may include one or more electronic documents that may define one or more activation parameters for one or more data record types. The data may be in the form of text. The text preprocessing module 310 may clean the ingested data to remove, for example, special characters, formatting issues, etc. and this may be done to standardize the data format. The text preprocessing module 310 may convert all of the text into lowercase to avoid distinctions. The text preprocessing module 310 may also remove common words that are not necessary for the classification. The text preprocessing module 310 may also perform lemmatization to reduce words to their base formats. The text preprocessing module 310 may utilize one or more software tools such as for example SpaCY, NLTK, Regex, etc.

The text representation module 320 may convert the data into a format that may be used by one or more machine learning models. For example, the text representation module 320 may convert words or phrases into numerical vectors that may capture semantic meaning thereof. The text representation module 320 may utilize contextual embeddings to represent words in context. The text representation module 320 may aggregate word embeddings to represent longer textual units like sentences. The text representation module 320 may utilize one or more software tools such as for example Word2Vec, FastTest, Glove, BERT or ROBERTa, etc.

The text classification module 330 may classify activation parameters into predefined categories. For example, the text classification module 330 may train one or more classifiers to recognize and categorize activation parameters based on a labeled dataset. The one or more classifiers may include text classification modules, for example, and the activation parameters may be classified according to their type, intent, or purpose. As another example, the text classification module 330 may use models capable of identifying multiple categories simultaneously. The text classification module 330 may utilize one or more software tools such as for example scikit-learn, TensorFlow, etc.

The intent detection and purpose recognition module 340 may understand the intent behind a particular activation parameter. The intent detection and purpose recognition module 340 may utilize one or more natural language processing (NLP) models to detect the specific purpose of each activation parameter. For example, the intent detection and purpose recognition module 340 may perform fine-grained text analysis to analyze activation parameters for specific actions or purposes. Further, the intent detection and purpose recognition module 340 may classify the purpose or intent of each activation parameter using one or more trained classifiers. The intent detection and purpose recognition module 340 may utilize one or more software tools such as for example SpaCy, Bert, OpenNLP, etc.

The extraction and segmentation module 350 may split the data into individual activation parameters for more efficient analysis. For example, the extraction and segmentation module 350 may automatically detect and segment data into logical activation parameters based on punctuation, terminology, or other delimiters. The extraction and segmentation module 350 may also standardize formats for consistency. The extraction and segmentation module 350 may utilize one or more software tools such as for example SpaCY, Regex, etc.

The activation parameter data model generation module 360 may compile and organize the recognized activation parameters into an activation parameter data model. For example, the activation parameter data model generation module 360 may aggregate the data to combine the identified and classified activation parameters into the database 140 in association with one or more data record types. Specifically, the activation parameter data model generation module 360 maps each activation parameter to one or more data record types that require processing of the activation parameter prior to creating or providing access to a data record of the one or more data record types. The activation parameter data model generation module 360 may consolidate the one or more activation parameters and this may be done to remove duplicate activation parameters and/or to combine two or more similar activation parameters. The activation parameter data model generation module 360 may store the activation parameter data model in the database 140 and may enable searching and filtering of the activation parameters. The activation parameter data model generated by the activation parameter data model generation module 360 may eliminate duplicate or overlapping activation parameters and as such the amount of computer memory required to store the activation parameter data model in the database 140 is reduced. The activation parameter data model generation module 360 may utilize one or more software tools such as for example Relational Databases, NoSQL Databases, Elasticsearch, etc.

The continuous learning/feedback module 370 may ensure the artificial intelligence engine 300 improves over time and adapts to new or emerging activation parameters. The continuous learning/feedback module 370 may utilize active learning to flag uncertain terms for human labeling and retrain the model. The continuous learning/feedback module 370 may periodically retrain the models with new data to improve performance and may utilize adaptive learning to update the system based on feedback. The continuous learning/feedback module 370 may utilize one or more software tools such as for example Label Studio, MLflow, etc.

The artificial intelligence engine 300 may be trained using supervised learning. For example, the artificial intelligence engine 300 may be trained using a labeled dataset where activation parameters are manually categorized into predefined classes. During supervised learning, the artificial intelligence engine 300 learns from the labeled dataset to recognize patterns in similar, unlabeled datasets. The artificial intelligence engine 300 may additionally be trained using unsupervised learning. For example, unsupervised methods such as for example clustering algorithms may be used to group similar activation parameters together. In this manner, the artificial intelligence engine 300 may be trained on a large set of data that includes a large number of activation parameters to recognize various types of activation parameters based on their intent. Further, the artificial intelligence engine 300 may be trained to determine one or more data record types that may require one or more of the activation parameters prior to creating or providing access to a data record of the one or more data record types.

In manners described herein, the artificial intelligence engine 300 utilizes a combination of NLP, machine learning, and deep learning techniques with modules focused on preprocessing, classification, intent detection, and continuous learning to generate an activation parameter data model that includes activation parameters mapped to one or more data record types that require processing of the activation parameters prior to creating or providing access to a data record of the one or more data record types. The artificial intelligence engine 300 efficiently processes a large amount of data and ensures consistent alignment between activation parameters and data record requirements. Further, the artificial intelligence engine 300 reduces redundancy and improves resource utilization by dynamically creating and maintaining an activation parameter data model. This ensures accurate and scalable management of activation parameters across various enterprise-level systems.

In addition to the activation parameter data model, the database 140 maintains one or more tables that link unique identifiers to previously processed activation parameters. In these embodiments, the unique identifiers may be associated with a particular user. For example, the unique identifiers may include a username or other identifying information of a user such as for example an email address, legal name, etc.

Within the database 140, the unique identifiers are linked to previously processed activation parameters. The previously processed activation parameters may include activation parameters previously processed by the unique identifier. For example, in one or more embodiments, activation parameters may include or represent preconditions such as for example terms and/or conditions that may be required to be processed or acknowledged to create a data record or to enable or access certain functionalities of the data record. When an activation parameter has been processed or acknowledged by the unique identifier, the activation parameters may be linked to the unique identifier. In this manner, the database maintains a list of all previously processed activation parameters linked to the unique identifier. The previously processed activation parameters may include previously processed activation parameters associated with one or more data record types.

In one or more embodiments, the table that links the unique identifiers to the previously processed activation parameters may include a Boolean flag that indicates the processing of the previously processed activation parameters. The Boolean flag may be set to a value of “TRUE” when the activation parameter has been processed.

In manners described herein, the server computer system 120 may engage the artificial intelligence engine 300 to analyze data to identify activation parameters and generate an activation parameter data model that maps the identified activation parameters to one or more data record types and may store the activation parameter data model in the database 140.

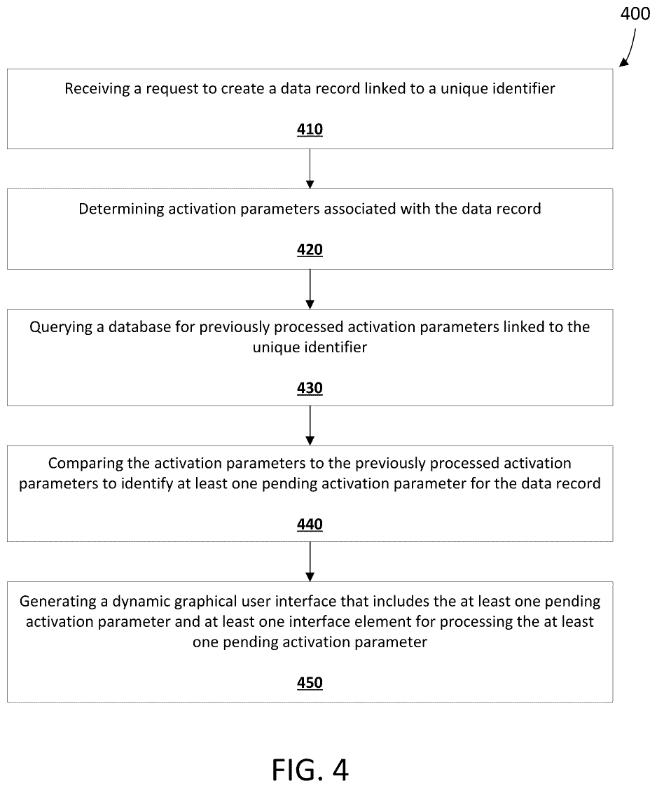

The activation parameter data model generated by the artificial intelligence engine 300 and the list maintained by the database 140 may be consulted to identify at least one pending activation parameter and to generate one or more dynamic graphical user interfaces for processing the at least one pending activation parameter. Reference is made to FIG. 4, which illustrates, in flowchart form, a method 400 for identifying at least one pending activation parameter and generating a dynamic graphical user interface for processing the at least one pending activation parameter. The method 400 may be implemented by a computing device having suitable processor-executable instructions for causing the computing device to carry out the described operations. The method 400 may be implemented, in whole or in part, by the server computer system 120.

The method 400 includes receiving a request to create a data record linked to a unique identifier (step 410).

The server computer system 120 may receive the request from the computing device 110 and the request may include the unique identifier. For example, a mobile application provided by the server computer system 120 may be installed and opened on the computing device 110. The user may log into the mobile application using authentication information such as for example a username and a password.

In one or more embodiments, the unique identifier may be determined based on the authentication information. For example, the server computer system 120 may identify the unique identifier based on the username used to log into the mobile application.

Within the mobile application, the user may select a selectable option to create a data record. In response, the computing device 110 may send a signal that includes a request to create the data record linked to the unique identifier. The signal may identify a data record type of the data record.

In one specific example, the mobile application may include a mobile banking application and as such the user may select a selectable option to create or open a new bank account such as for example a chequing account or a savings account. In this example, the signal may identify a data record type such as for example a chequing account or a savings account.

In another specific example, the mobile application may be associated with media service accounts and as such the user may select a selectable option to create, open, or upgrade a new media service account.

The method 400 includes determining activation parameters associated with the data record (step 420).

The activation parameters may include or represent preconditions such as for example terms and/or conditions that may be required to be processed or acknowledged to create the data record or to enable or access certain functionalities of the data record. In one specific example, where the data record may include a bank account, the activation parameters may include terms and/or conditions that must be acknowledged or processed prior to creating the bank account and/or prior to providing access to the bank account.

When determining the activation parameters associated with the data record, the server computer system 120 may determine a data record type of the data record. For example, as mentioned, the request to create a data record linked to the unique identifier may identify the data record type.

In one or more embodiments, the server computer system 120 queries the database to obtain the activation parameters based on the data record type. For example, the server computer system 120 may generate a query that includes a request to perform a lookup using the data record type. The activation parameters may be retrieved using the data record type and in this manner the activation parameters associated with the data record may be determined.

In one or more embodiments, the activation parameters may be identified using an activation parameter identifier which may be labeled as a process type within the database 140.

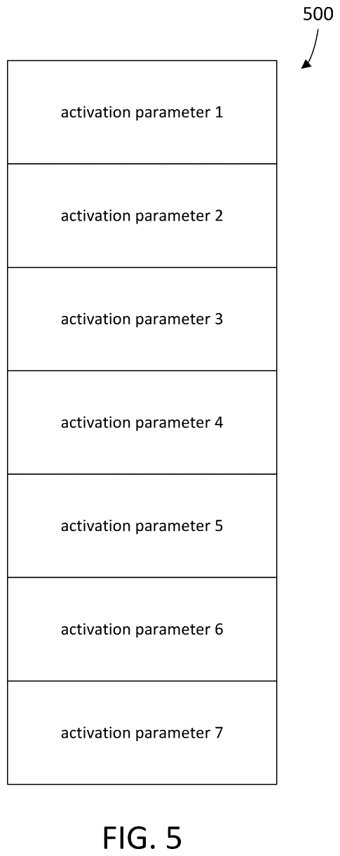

An example list of activation parameters 500 for a data record of a particular data record type is shown in FIG. 5. As can be seen, the list includes activation parameter 1, activation parameter 2, activation parameter 3, activation parameter 4, activation parameter 5, activation parameter 6, and activation parameter 7. The activation parameters shown in the list of activation parameters 500 include or represent preconditions that may be required to be processed or acknowledged to create a data record of the particular data record type or to enable or access certain functionalities of a data record of the particular data record type.

The method 400 includes querying a database for previously processed activation parameters linked to the unique identifier (step 430).

The server computer system 120 queries the database 140 for previously processed activation parameters linked to the unique identifier. For example, as mentioned, the database 140 maintains a list of all previously processed activation parameters linked to the unique identifier. As such, the server computer system 120 queries the database to obtain a list of previously processed activation parameters linked to the unique identifier.

In one or more embodiments, the previously processed activation parameters may include previously processed activation parameters associated with one or more other data record types. For example, the request to create the data record may include a request to create a data record of a first data record type. The user, identified by the unique identifier, may have previously processed activation parameters associated with a second data record type. As such, the previously processed activation parameters linked to the unique identifier may include the previously processed activation parameters associated with the second data record type.

In one or more embodiments, the previously processed activation parameters may be identified using an activation parameter identifier which may be labeled as a process type within the database 140.

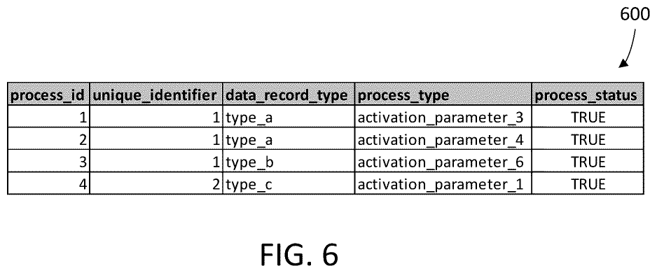

Exemplary data records 600 listing previously processed activation parameters are shown in FIG. 6. In this example, the data records are identified by “process_id”. The data records are linked with a unique identifier such as for example “1” or “2”. The data records include a data record type indicating the data record type that was created or accessed in response to processing of the corresponding activation parameter. The data records include the particular activation parameter that was processed such as for example “activation_parameter_3”. The data records also include a process status which may include a Boolean flag indicating that the activation parameter has been processed (“TRUE”). Of course, the Boolean flag may be set to “FALSE” when the processing of the activation parameter results in an error or if the processing of the activation parameter has expired.

The method 400 includes comparing the activation parameters to the previously processed activation parameters to identify at least one pending activation parameter for the data record (step 440).

The server computer system 120 compares the activation parameters associated with the data record to the previously processed activation parameters to identify at least one pending activation parameter for the data record. The at least one pending activation parameter may include at least one activation parameter associated with the data record that was not included in the previously processed activation parameters. Put another way, the at least one pending activation parameter includes at least one activation parameter that has not yet been processed.

As one specific example, the activation parameters may include or represent preconditions such as for example terms and/or conditions that may be required to be processed or acknowledged to create the data record or to enable or access certain functionalities of the data record. As such, the at least one pending activation parameter may include or represent preconditions such as for example terms and/or conditions that have not been processed or acknowledged by the user.

As one example, a request to create a data record may include a request to create a data record of the particular data record type and linked to a unique identifier “1”. As such, the list of activation parameters associated with the data record may include the list of activation parameters 500 shown in FIG. 5. The database may be queried for previously processed activation parameters linked to the unique identifier “1” and the data records shown in FIG. 6 may be utilized to determine that the previously processed activation parameters linked to the unique identifier “1” may include activation parameter 3, activation parameter 4, and activation parameter 6. As such, comparing the list of activation parameters 500 to the previously processed activation parameters linked to the unique identifier “1” the at least one pending activation parameter may be identified as activation parameter 1, activation parameter 2, activation parameter 5, and activation parameter 7.

The method 400 includes generating a dynamic graphical user interface that includes the at least one pending activation parameter and at least one interface element for processing the at least one pending activation parameter (step 450).

The server computer system 120 generates a dynamic graphical user interface that includes the at least one pending activation parameter and at least one interface element for processing the at least one pending activation parameter.

In one or more embodiments, the dynamic graphical user interface may include all pending activation parameters and a single interface element for processing all pending activation parameters.

As one specific example, the at least one pending activation parameter may include or represent preconditions such as for example terms and/or conditions that have not been processed or acknowledged by the user. As such, the dynamic graphical user interface may be generated as a digital consent form that lists all pending activation parameters in a numerical order and the signal indicating processing of the at least one pending activation parameter may include a signal indicating acknowledgement of the terms and/or conditions displayed on the digital consent form.

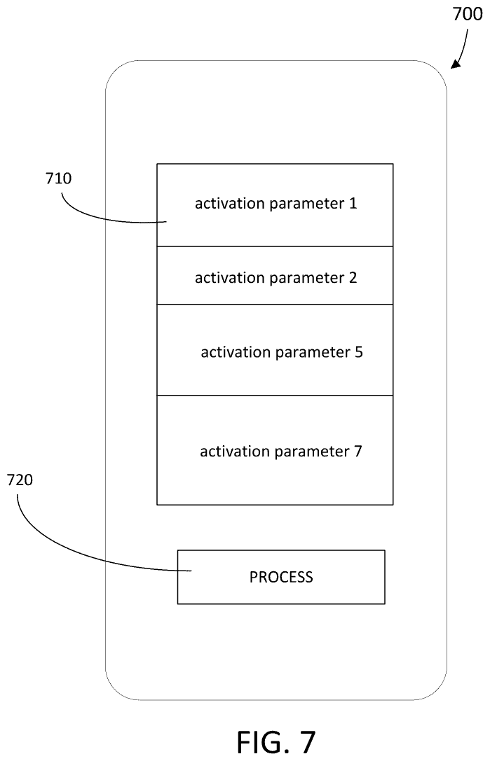

An example dynamic graphical user interface 700 is shown in FIG. 7. As mentioned, in one example the at least one pending activation parameter may be identified as activation parameter 1, activation parameter 2, activation parameter 5, and activation parameter 7. As such, the dynamic graphical user interface includes the pending activation parameters 710. The dynamic graphical user interface 700 includes an interface element 720 that may be selected to process the activation parameters.

As one specific example, the at least one pending activation parameter may include or represent preconditions such as for example terms and/or conditions that have not been processed or acknowledged by the user. As such, the dynamic graphical user interface may be generated as a digital consent form that lists all pending activation parameters in a numerical order.

In one or more embodiments, the dynamic graphical user interface may include an additional interface element for viewing the previously processed activation parameters.

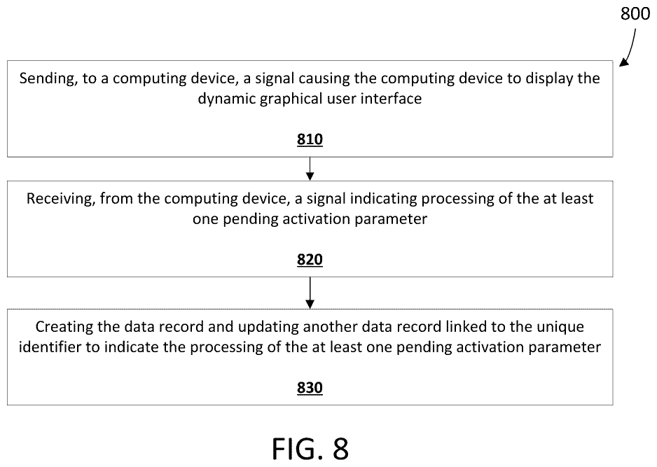

The server computer system 120 may send the dynamic graphical user interface to a computing device and may perform operations to create the data record. Reference is made to FIG. 8, which illustrates, in flowchart form, a method 800 for creating the data record. The method 800 may be implemented by a computing device having suitable processor-executable instructions for causing the computing device to carry out the described operations. The method 800 may be implemented, in whole or in part, by the server computer system 120.

The method 800 includes sending, to a computing device, a signal causing the computing device to display the dynamic graphical user interface (step 810).

The server computer system 120 sends a signal that causes the computing device 110 to display the dynamic graphical user interface. In one or more embodiments, the dynamic graphical user interface may be displayed within a mobile application executing on the computing device 110. The dynamic graphical user interface may include the dynamic graphical user interface generated during the step 450 of the method 400 and may include the at least one pending activation parameter and at least one interface element for processing the at least one pending activation parameter.

As one example, the server computer system 120 may send a signal causing the computing device to display the dynamic graphical user interface 700 shown in FIG. 7.

The method 800 includes receiving, from the computing device, a signal indicating processing of the at least one pending activation parameter (step 820).

The user may select the at least one interface element for processing the at least one pending activation parameter by performing, for example, a tap gesture on a display screen of the computing device 110 that corresponds to a location of the at least one interface element. In response, the computing device 110 may send a signal indicating processing of the at least one pending activation parameter.

As one example, with reference to FIG. 7, the user may select the interface element 720 for processing the activation parameters 710.

Responsive to receiving the signal indicating processing of the at least one pending activation parameter, the method 800 includes creating the data record and updating another data record linked to the unique identifier to indicate the processing of the at least one pending activation parameter (step 830).

Responsive to receiving the signal indicating processing of the at least one pending activation parameter, the server computer system 120 may perform operations to create the data record.

In one or more embodiments, the activation parameters may include or represent preconditions such as for example terms and/or conditions that may be required to be processed or acknowledged to create the data record or to enable or access certain functionalities of the data record. As such, in one or more embodiments, only after the at least one pending activation parameter has been processed does the server computer system 120 create the data record. For example, in embodiments where the request to create the data record includes a request to open a bank account, the server computer system 120 may perform operations to create a data record for the bank account and to link the data record to the unique identifier.

The server computer system 120 may update another data record linked to the unique identifier to indicate the processing of the at least one pending activation parameter. For example, as mentioned, the database 140 may maintain a list of all previously processed activation parameters linked to the unique identifier. As such, responsive to receiving the signal indicating processing of the at least one pending activation parameter, the server computer system 120 may update the list to include the at least one pending activation parameter. In this manner, the server computer system 120 may continuously update the list to track all activation parameters that have been processed or acknowledged and may link the processed activation parameters to the unique identifier.

In one or more embodiments, the another data record may include a Boolean flag that may indicate the processing of the at least one pending activation parameter and the server computer system 120 may update the Boolean flag to a value of TRUE.

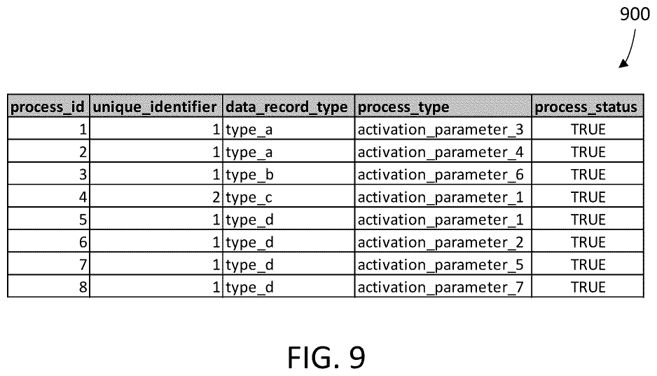

Exemplary updated data records 900 are shown in FIG. 9. As can be seen, the data records 600 shown in FIG. 6 are updated to include data records for the now previously processed activation parameter 1, activation parameter 2, activation parameter 5, and activation parameter 7 and these data records are linked to the unique identifier “1”.

In manners described herein, access to the data record may only be provided when all activation parameters associated with the data record have been processed.

As mentioned, in one or more embodiments, the dynamic graphical user interface may include an additional interface element for viewing the previously processed activation parameters. The user may select the additional interface element and the computing device 110 may send a signal to the server computer system 120 indicating selection of the additional interface element. In response, the server computer system 120 may perform operations to cause the computing device 110 to display a list of the previously processed activation parameters.

In accordance with the artificial intelligence engine, systems and methods described herein, only activation parameters that have not yet been processed for a unique identifier are identified and pending activation parameters. By only processing the pending activation parameters, unnecessary over consumption or over usage of computing resources is eliminated. Put another way, since only the pending activation parameters are processed, the repeated processing or reprocessing of one or more activation parameters is eliminated. Further, data storage in the database described herein is reduced as duplicate data records are eliminated. For example, data records indicating the processing of a particular activation parameter for two or more data record types linked to the same unique identifier may be consolidated to reduce memory usage.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A server computer system comprising:
a communications module;
at least one processor coupled with the communications module; and
a memory coupled to the at least one processor and storing processor-executable instructions which, when executed by the at least one processor, configure the at least one processor to:
receive a request to create a data record linked to a unique identifier;
determine activation parameters associated with the data record;
query a database for previously processed activation parameters linked to the unique identifier;
compare the activation parameters to the previously processed activation parameters to identify at least one pending activation parameter for the data record; and
generate a dynamic graphical user interface that includes the at least one pending activation parameter and at least one interface element for processing the at least one pending activation parameter.

2. The server computer system of claim 1, wherein the instructions, when executed by the at least one processor, further configure the at least one processor to:
send, via the communications module and to a computing device, a signal causing the computing device to display the dynamic graphical user interface; and
receive, via the communications module and from the computing device, a signal indicating processing of the at least one pending activation parameter.

3. The server computer system of claim 2, wherein the instructions, when executed by the at least one processor, further configure the at least one processor to:
responsive to receiving the signal indicating processing of the at least one pending activation parameter, create the data record and update another data record linked to the unique identifier to indicate the processing of the at least one pending activation parameter.

4. The server computer system of claim 3, wherein the another data record includes a Boolean flag indicating the processing of the at least one pending activation parameter.

5. The server computer system of claim 1, wherein when determining the activation parameters associated with the data record, the instructions, when executed by the at least one processor, further configure the at least one processor to:
determine a data record type of the data record; and
query the database to obtain the activation parameters based on the data record type.

6. The server computer system of claim 1, wherein the instructions, when executed by the at least one processor, further configure the at least one processor to:
engage an artificial intelligence engine to analyze data to identify activation parameters and generate an activation parameter data model that maps the identified activation parameters to one or more data record types; and
store the activation parameter data model in the database.

7. The server computer system of claim 1, wherein the instructions, when executed by the at least one processor, further configure the at least one processor to:
determine that all activation parameters associated with the data record have been processed; and
responsive to determining that all activation parameters associated with the data record have been processed, create to the data record.

8. The server computer system of claim 1, wherein the dynamic graphical user interface includes all pending activation parameters and a single interface element for processing all pending activation parameters.

9. The server computer system of claim 1, wherein the database maintains a list of all previously processed activation parameters linked to the unique identifier.

10. The server computer system of claim 9, wherein the previously processed activation parameters include previously processed activation parameters associated with one or more other data record types.

11. A computer-implemented method comprising:
receiving a request to create a data record linked to a unique identifier;
determining activation parameters associated with the data record;
querying a database for previously processed activation parameters linked to the unique identifier;
comparing the activation parameters to the previously processed activation parameters to identify at least one pending activation parameter for the data record; and
generating a dynamic graphical user interface that includes the at least one pending activation parameter and at least one interface element for processing the at least one pending activation parameter.

12. The computer-implemented method of claim 11, further comprising:
sending, via a communications module and to a computing device, a signal causing the computing device to display the dynamic graphical user interface; and
receiving, via the communications module and from the computing device, a signal indicating processing of the at least one pending activation parameter.

13. The computer-implemented method of claim 12, further comprising:
responsive to receiving the signal indicating processing of the at least one pending activation parameter, creating the data record and updating another data record linked to the unique identifier to indicate the processing of the at least one pending activation parameter.

14. The computer-implemented method of claim 13, wherein the another data record includes a Boolean flag indicating the processing of the at least one pending activation parameter.

15. The computer-implemented method of claim 11, wherein when determining the activation parameters associated with the data record, the method comprises:
determining a data record type of the data record; and
querying the database to obtain the activation parameters based on the data record type.

16. The computer-implemented method of claim 11, further comprising:
engaging an artificial intelligence engine to analyze data to identify activation parameters and generate an activation parameter data model that maps the identified activation parameters to one or more data record types; and
storing the activation parameter data model in the database.

17. The computer-implemented method of claim 11, further comprising:
determining that all activation parameters associated with the data record have been processed; and
responsive to determining that all activation parameters associated with the data record have been processed, creating the data record.

18. The computer-implemented method of claim 11, wherein the database maintains a list of all previously processed activation parameters linked to the unique identifier.

19. The computer-implemented method of claim 18, wherein the previously processed activation parameters include previously processed activation parameters associated with one or more other data record types.

20. A non-transitory computer readable storage medium comprising computer-executable instructions which, when executed, configure a processor to:
receive a request to create a data record linked to a unique identifier;
determine activation parameters associated with the data record;
query a database for previously processed activation parameters linked to the unique identifier;
compare the activation parameters to the previously processed activation parameters to identify at least one pending activation parameter for the data record; and
generate a dynamic graphical user interface that includes the at least one pending activation parameter and at least one interface element for processing the at least one pending activation parameter.
